(19) United States
(12) Patent Application Publication
(10) Pub. No.: US 2006/0249213 A1
(43) Pub. Date: Nov. 9, 2006

(54) Plastic coated metal heater and water tube assembly

(76) Inventors: David C. Stieler, Lake Orion, MI (US); Dale L. Sleep, Clarkston, MI (US)

Correspondence Address: DYKEMA GOSSETT PLLC, Suite 300, 39577 Woodward Avenue, Bloomfield Hills, MI, 48304, US

(21) Appl. No.: 11/111,268

(22) Filed: Apr. 21, 2005

(51) Int. Cl. F16L 11/00

(52) U.S. Cl. 138/109; 138/139

(57) ABSTRACT

An improved fluid flow assembly for the heating and cooling system of a motor vehicle is provided that reduces the weight of the system and reduces manufacturing costs by reducing or eliminating the need for conventional manufacturing methods such as brazing, high heat welding, or post plating. The improved fluid flow assembly includes one more tubes disposed between, and conducting fluid between, any two of the vehicle engine, the heater core, and the radiator along with a polymeric connector The tube is formed as a laminate having a metallic layer and a polymeric layer. The polymeric layer of the tube is bonded directly to the connector to define a hermetic seal.

### BACKGROUND OF THE INVENTION

1. Field of the Invention

The present invention relates to fluid handling systems in vehicles and, in particular, to a fluid flow assembly for a heating and cooling system of a motor vehicle.

2. Discussion of Related Art

In a conventional vehicle heating and cooling system, engine coolant travels between a vehicle engine, a radiator, and a heater core. In particular, coolant is provided to the engine and heat is transferred from the engine to the coolant. Upon exiting the engine, the coolant flows to one or both of the radiator and the heater core. Heat is then vented into the air by the radiator or into the passenger compartment of the vehicle by the heater core, respectively. Finally, the coolant returns from the radiator and/or heater core to a pump that provides the coolant to the engine again.

The tubing used to transport fluid in conventional vehicle heating and cooling systems may be made of metals, such as carbon steel or stainless steel, having a relatively high weight, thereby adding to the total weight of the vehicle with a resulting reduction in fuel economy. More significantly, tubing made of carbon steel or stainless steel is relatively expensive to manufacture. In particular, manufacture and assembly of the components in a typical fluid flow assembly require the use of brazing, high heat welding, post plating, and other costly manufacturing methods. These high-energy manufacturing methods may also be highly time-intensive, resulting in an increased assembly time for conventional vehicle fluid flow assemblies.

The inventors herein have recognized a need for a fluid flow assembly for a heating and cooling system of a motor vehicle that will minimize and/or eliminate the above-identified deficiencies.

### SUMMARY OF THE INVENTION

The present invention provides a fluid flow assembly for a heating and cooling system of a motor vehicle. The fluid flow assembly includes a tube disposed between, and conducting fluid between, two of an engine, a heater core, and a radiator. The tube is formed as a laminate having a metallic layer and a polymeric layer. The fluid flow assembly further includes a polymeric connector. The polymeric layer of the tube is bonded directly to the connector to define a hermetic seal.

A fluid flow assembly in accordance with the present invention is advantageous as compared to existing fluid flow assemblies for heating and cooling systems of motor vehicles. First, a fluid flow assembly in accordance with the present invention reduces the weight of the heating and cooling system, thereby reducing the total weight of the vehicle and improving fuel economy. Second, a fluid flow assembly in accordance with the present invention greatly reduces manufacturing costs by reducing or eliminating the need for expensive manufacturing methods, such as brazing, high heat welding, and post plating.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a block diagram illustrating a heating and cooling system for a motor vehicle incorporating a fluid flow assembly in accordance with the present invention.

FIGS. 2-3 are perspective views of a fluid flow assembly of FIG. 1.

FIG. 4 is a cross-sectional view of the fluid flow assembly of FIG. 1.

FIG. 5 is a cross-section view of a fluid flow assembly in accordance with another embodiment of the present invention.

FIG. 6 is a cross-sectional view of a fluid flow assembly in accordance with yet another embodiment of the present invention.

### DETAILED DESCRIPTION OF EMBODIMENTS OF THE INVENTION

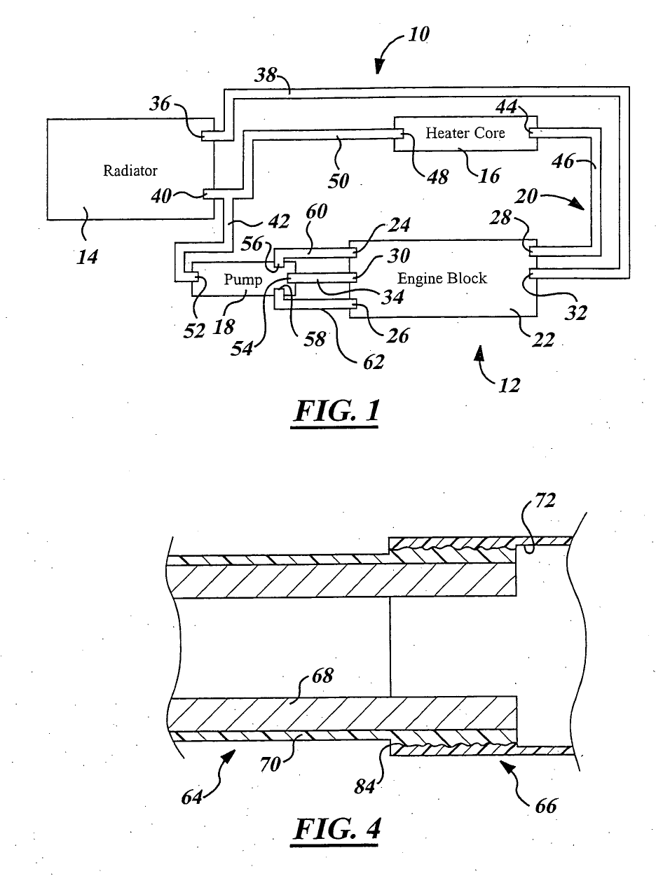

Referring now to the drawings wherein like reference numerals are used to identify identical components in the various views, FIG. 1 illustrates a fluid handling system 10 for a vehicle having an engine 12, a radiator 14, a heater core 16, a pump 18, and a plurality of fluid flow assemblies 20 extending between engine 12, radiator 14, heater core 16 and pump 18. The fluid flow system in FIG. 1 is intended to be illustrative. It should be understood, therefore, that the particular fluid flow circuit is not intended to limit the scope of the claimed invention.

Engine 12 provides motive power to the vehicle and may comprise any of a wide variety of conventional engines. Engine 12 may include an engine block 22, a cylinder head (not shown), a crossover casting (not shown), and an intake manifold (not shown) that together define a plurality of cylinders (not shown) and fluid passages (not shown) configured to allow an engine coolant to circulate within engine 12. As will be understood by those in the art, the composition of the engine coolant may vary, but typically will include water. Engine 12 also defines one or more inlets 24, 26 configured to receive coolant from pump 18 and one or more outlets 28, 30, 32 configured to allow coolant to exit engine 12. In the illustrated embodiment, engine 12 includes three outlets 28, 30, 32 that deliver coolant to heater core 16, pump 18—through a bypass 34—and radiator 14.

Radiator 14 is provided to vent heat from the engine coolant to the air. Radiator 14 is conventional in the art and includes an inlet 36 that receives coolant from engine 12 through a fluid flow assembly 38 and an outlet 40 that provides coolant to a fluid flow assembly 42 leading to pump 18.

Heater core 16 is provided to deliver heat to the passenger compartment of the vehicle and is also conventional in the art. Core 16 includes an inlet 44 that receives coolant from engine 12 through a fluid flow assembly 46 and an outlet 48 that delivers coolant to pump 18 through another fluid flow assembly 50.

Pump 18 is provided to force the engine coolant through system 10 and is also conventional in the art. Pump 18 includes one or more inlets 52, 54 configured to receive coolant from radiator 14 and heater core 16 through fluid flow assembly 42 and from engine 12 through bypass 34. Pump 18 includes one or more outlets 56, 58 configured to deliver coolant to fluid flow assemblies 60, 62 leading to inlets 24, 26 of engine 12.

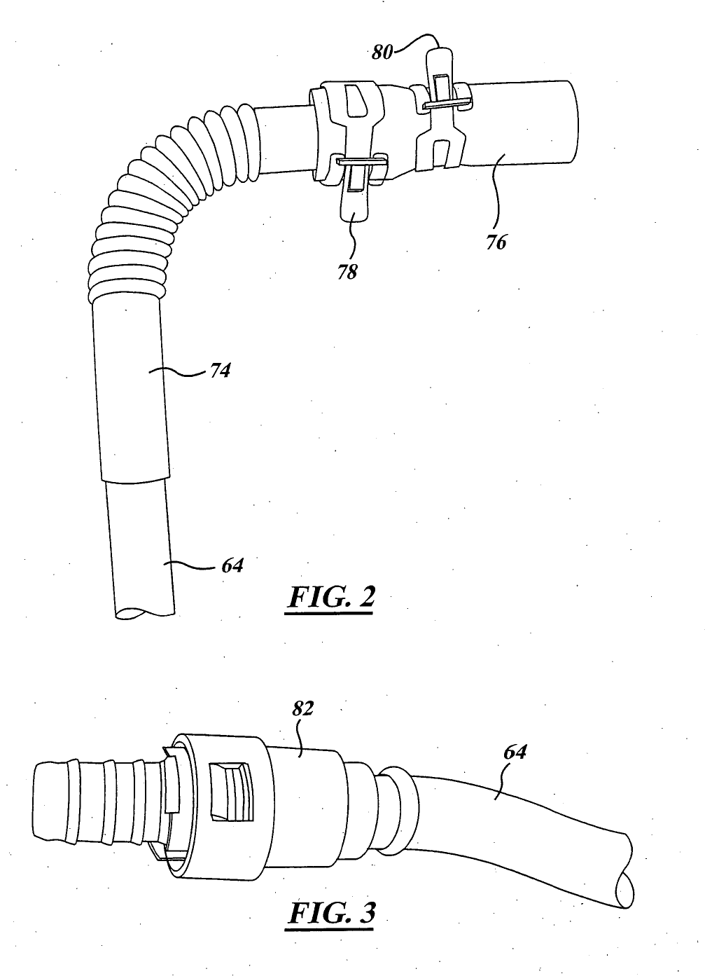

Referring now to FIGS. 2-4, a fluid flow assembly 20 in accordance with the present invention will be described and illustrated. Assemblies 20 (such as fluid flow assemblies 34, 38, 42, 46, 50, 60 and 62) are provided to transport fluid between the components of system 10 including engine 12, radiator 14, heater core 16 and pump 18. In accordance with the present invention, a fluid flow assembly 20 includes a tube 64 disposed between, and conducting fluid between, any two of engine 12, radiator 14 and heater core 16 along with a connector 66.

Tube 64 is provided to transport fluid between two points. Referring to FIG. 4, tube 64 may be formed as a laminate having an inner layer 68 and an outer layer 70. As used herein, the term “inner” layer and “outer” layer are used to describe the relative position of layers 68, 70 to one another. The use of “inner” and “outer” does not mean that the “inner” layer is the innermost layer, that the “outer” layer is the outermost layer, or that there cannot be layers in between layers 68, 70. Further, although only one tube 64 is shown in FIGS. 2-3, it should be understood that a plurality of tubes 64 could be coupled together as part of assembly 20. Layer 68 is a metallic layer and may comprise steel or, in a preferred embodiment, aluminum. The thickness of the inner metallic layer 68 may measure substantially 0.1 mm to 2.0 mm. However, although this thickness is described in detail, it is to be understood that those of ordinary skill in the art will recognize that the inner metallic layer may be thicker or thinner and still fall within the spirit and scope of the invention. Outer layer 70 is a polymeric layer, and preferably a plastic layer (in particular a thermoplastic layer) and comprises nylon in a preferred embodiment. Nylon refers to a family of polyamides generally characterized by the presence of the amide group, —CONH. In a preferred embodiment, the nylon is of a type known as nylon 12. Outer layer 70 may measure substantially 150 microns in thickness, but may preferably range between about 80 and about 500 microns. Again, however, it is to be understood that those of ordinary skill in the art will recognize that the outer polymeric layer may be thicker or thinner and still fall within the spirit and scope of the invention.

Outer layer 70 may be directly adjacent to the inner layer 68 and may be extruded over, or otherwise pre-bonded to, inner layer 68. Alternatively, tube 64 may include additional layers disposed between inner layer 68 and outer layer 70 or additional layers may be formed inwardly of inner layer 68. Further, either of layers 68, 70 may comprise a plurality of sub-layers. For example layer 70 may comprise a plurality of polymeric sublayers having different compositions.

Connector 66 is provided to couple tube 64 to another tube 64 or to one of the components of system 10 such as engine 12, radiator 14, heater core 16 or pump 18. Connector 66 is a polymeric connector, preferably plastic (in particular a thermoplastic). Connector 66 includes a port 72 configured to receive one end of tube 64. Connector 66 may include additional ports configured to receive additional tubes 64 or connectors associated with engine 12, radiator 14, heater core 16 or pump 18. Connector 66 may assume the form of any of a wide variety of connectors conventionally used within vehicle heating and cooling systems. Referring to FIG. 2, connector 66 may comprise a flexible connector 74, such as a tube, part or all of which may be corrugated. In the embodiment illustrated in FIG. 2, tube 64 is inserted into one port of connector 74 while another port may be coupled to engine 12 using a section of rubber hose 76 and one or more clamps 78, 80 as is known in the art. Referring to FIG. 3, connector 66 may comprise a rigid connector 82 and may particularly comprise a quick connect connector. In the embodiment illustrated in FIG. 3, tube 64 is inserted into one port of connector 82 while another port may be coupled to heater core 16. It should be understood that the particular connectors 74, 82 shown in FIGS. 2-3 are exemplary only and are not intended to limit the scope of the invention.

Referring again to FIG. 4, tube 64 and connector 66 are joined by bonding the polymeric layer of tube 64 directly to connector 66 to define a hermetic bond or seal 84. The bonding may be accomplished through the use of induction welding to generate within inner layer 68 and generate heat transfer from inner layer 68 of tube 64 to outer layer 70 to deform layer 70 (and potentially connector 66) and form the seal 84. This process is described and illustrated in commonly assigned, pending U.S. patent application Ser. No. 11/042,014 filed Jan. 25, 2005 and tilted “Method of Coupling Fuel System Components,” the entire disclosure of which is incorporated herein by reference. Alternatively, the bonding may be accomplished by moving one or both of tube 64 and connector 66 to generate frictional heat between outer layer 70 of tube 64 and connector 66 to deform layer 70 of tube 64 (and possibly connector 66) and form seal 84. This process is described and illustrated in commonly assigned, pending U.S. patent application Ser. No. 11/042,013 filed Jan. 25, 2005 and tilted “Method of Coupling Fuel System Components,” the entire disclosure of which is incorporated herein by reference. As another alternative, heat may be applied to the interface of layer 70 of tube 64 and connector 66 to deform layer 70 (and possibly connector 66) and form seal 84. Heat may be applied to the interface using a variety of energy sources including laser welding.

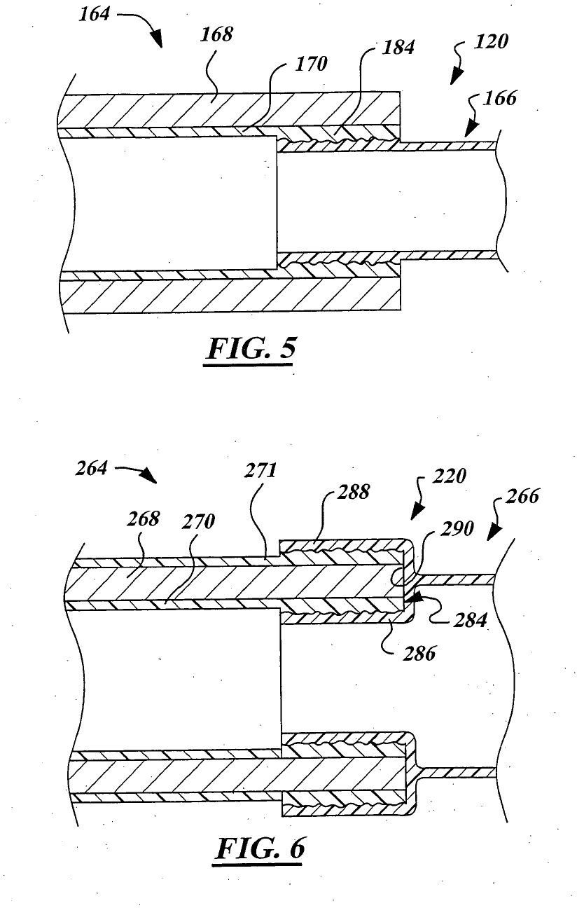

Referring now to FIG. 5, a fluid flow assembly 120 in accordance with another embodiment of the present invention is illustrated. Fluid flow assembly 120 includes a tube 164 and a connector 166 and is substantially similar to assembly 20. In fluid flow assembly 120, however, tube 164 includes an outer metallic layer 168 and an inner polymeric layer 170. Layers 168, 170 may be made from the same materials and have the same characteristics as described hereinabove with respect to layers 68, 70 of tube 64 of assembly 20. Connector 166 is inserted within one end of tube 164 as opposed to receiving one end of tube 64 as in assembly 20 and tube 164 and connector 166 are joined by bonding the polymeric layer 170 of tube 164 directly to connector 166 to define a hermetic bond or seal 184 using one of the above-described methods. Connector 66 may be me made from the same materials and have the same characteristics described hereinabove with respect to connector 66 of assembly 20.

Referring now to FIG. 6, a fluid flow assembly 220 in accordance with the another embodiment of the present invention is illustrated. Fluid flow assembly 220 includes a tube 264 and a connector 266 and is substantially similar to assemblies 20, 120. In fluid flow assembly 220, however, tube 264 includes a metallic layer 268 and polymeric layers 270, 271 disposed both inwardly and outwardly of layer 268. Layers 268, 270 and 271 may be made from the same materials and have the same characteristics as described hereinabove with respect to layers 68, 70 of tube 64 of assembly 20. Connector 266 defines inner and outer concentric annular walls 286, 288 defining an annular space 290 therebetween. One end of tube 264 is inserted within space 290 and tube 264 and connector 266 are joined by bonding the polymeric layers 270, 271 of tube 264 directly to connector 266 to define a hermetic bond or seal 284 using one of the above-described methods. Connector 266 may be me made from the same materials and have the same characteristics described hereinabove with respect to connector 66 of assembly 20.

A fluid flow assembly 20, 120, of 220 in accordance with the present invention is advantageous as compared to conventional fluid flow assemblies. In particular, the fluid flow assemblies are significantly lighter than conventional fluid flow assemblies thereby reducing the weight of the fluid flow assembly and the total weight of the vehicle and improving fuel economy. More significantly, the fluid flow assemblies reduce or eliminate the need for conventional manufacturing processes such as brazing, high heat welding, and post plating that require relatively large amounts of time and resources (e.g., energy).

While the invention has been particularly shown and described with reference to the preferred embodiments thereof, it is well known by those skilled in the art that various changes and modifications can be made in the invention without departing from the spirit and scope of the invention.

We claim:

1. A fluid flow-assembly for a heating and cooling system of a motor vehicle, comprising:
a tube disposed between, and conducting fluid between, two of an engine, a heater core, and a radiator, said tube formed as a laminate having a metallic layer and a first polymeric layer; and
a polymeric connector
wherein said first polymeric layer of said tube is bonded directly to said connector to define a hermetic seal.

2. The fluid flow assembly of claim 1 wherein said metallic layer comprises aluminum.

3. The fluid flow assembly of claim 1 wherein said metallic layer comprises steel.

4. The fluid flow assembly of claim 1 wherein said first polymeric layer comprises a plastic.

5. The fluid flow assembly of claim 1 wherein said first polymeric layer comprises nylon.

6. The fluid flow assembly of claim 1 wherein said first polymeric layer is directly adjacent said metallic layer.

7. The fluid flow assembly of claim 1 wherein said first polymeric layer is extruded over said metallic layer.

8. The fluid flow assembly of claim 1 wherein said connector is rigid.

9. The fluid flow assembly of claim 1 wherein said connector is flexible.

10. The fluid flow assembly of claim 1 wherein said connector comprises a tube.

11. The fluid flow assembly of claim 1 wherein said connector comprises a quick connect connector.

12. The fluid flow assembly of claim 1 wherein said tube is disposed between said engine and said heater core.

13. The fluid flow assembly of claim 1 wherein said tube is disposed between said engine and said radiator.

14. The fluid flow assembly of claim 1 wherein said first polymeric layer of said tube is bonded directly to said connector by generating heat transfer from said metallic layer of said tube to said first polymeric layer to deform said first polymeric layer.

15. The fluid flow assembly of claim 1 wherein said first polymeric layer of said tube is bonded directly to said connector by generating frictional heat between said first polymeric layer of said tube and said polymeric connector.

16. The fluid flow assembly of claim 1 wherein said first polymeric layer of said tube is bonded directly to said connector by applying heat at the interface of said first polymeric layer and said polymeric connector.

17. The fluid flow assembly of claim 1 wherein said first polymeric layer is disposed inwardly of said metallic layer and said connector is inserted into said tube.

18. The fluid flow assembly of claim 1 wherein said first polymeric layer is disposed outwardly of said metallic layer and said tube is inserted into a port defined in said connector.

19. The fluid flow assembly of claim 1 wherein said tube includes a second polymeric layer, said first and second polymeric layers disposed on opposite sides of said metallic layer.

20. The fluid flow assembly of claim 19 wherein both of said first and second polymeric layers of said tube are bonded directly to said connector to define a hermetic seal.
